(19) United States
(12) Patent Application Publication
(10) Pub. No.: US 2022/0273010 A1
(43) Pub. Date: Sep. 1, 2022

(54) SUGAR SUBSTITUTE COMPOSITIONS

(71) Applicant: SWEET BALANCE LTD, Kiryat Shmona (IL)

(72) Inventor: Danny DIZER, Rishon LeZion (IL)

(21) Appl. No.: 17/624,346

(22) PCT Filed: Jun. 30, 2020
(86) PCT No.: PCT/IL2020/050725

§ 371 Date: Jan. 2, 2022

Related U.S. Application Data
(60) Provisional application No. 62/869,618, filed on Jul. 2, 2019.

(51) Int. Cl. A23L 27/30

(52) U.S. Cl. CPC A23L 27/33; A23L 27/31

(57) ABSTRACT

The present invention is directed to compositions comprising inter alia, an oligosaccharide, a monk fruit-derived material, a masking agent, and a soluble fiber, and use of same, such as a sugar substitute.

### CROSS-REFERENCE TO RELATED APPLICATIONS

This application claims the benefit of priority of U.S. Provisional Patent Application No. 62/869,618 titled “SUGAR SUBSTITUTE COMPOSITIONS”, filed Jul. 2, 2019, the contents of which are incorporated herein by reference in their entirety.

### FIELD OF THE INVENTION

The present invention is directed to; inter alia, sugar substitute compositions and methods of manufacturing the same, and using the compositions in the preparation of food products.

### BACKGROUND

In recent years, sugar free foods have gained popularity due to their lower calorie content. The food industry uses various artificial sweeteners as sugar replacements, which are low in calorie content compared to the high calorie content of sugar.

In the food industry, oligosaccharides are utilized as: (i) dietary fibers; (ii) sweeteners (comparably or similarly to sugar); and (iii) bulking agents (in cases when the sweetener is a high-intensive sweetener).

The U.S. Food and Drug Administration has approved artificial sweeteners such as aspartame, acesulfame-k, neotame, cyclamate, and alitame, for use as per “acceptable daily intake (ADI)” value. However, the breakdown products of these sweeteners have controversial health and metabolic effects.

Some natural sugar substitutes such as the sweetener stevia, which is derived from a plant extract, have aftertaste limitations, such as a bitter taste, a metallic taste, being astringent, and inducing a long lasting sweet sensation, all in contrast to white sugar-sucrose.

Other sugar replacement currently being used include polysaccharides, and sugars alcohols. However, such polysaccharides are known induce laxative effects, and are therefore being added in a fairly limited amount, which counteracts their sweetening activity.

Therefore, there is still a need for a proper sugar substitute that provides a balanced sense of sweetness and sweetness time-profile comparable to sugar, but with a low-calorie content, and without the drawbacks of most artificial sweeteners, e.g., lingering off-taste, sugar alcohols laxative effects, and others.

### SUMMARY

According to a first aspect, there is provided a composition comprising: (a) an oligosaccharide; (b) a monk fruit derived material; (c) a soluble fiber; and (d) date syrup.

According to another aspect, there is provided a method for preparing a food product that requires an amount of sugar, comprising substituting an amount of sugar required for preparing the food product with an equivalent amount of the composition of the invention.

In some embodiments, the monk fruit derived material is selected from the group consisting of: monk fruit juice concentrate, monk fruit extract, monk fruit pulp, and any combination thereof.

In some embodiments, the date syrup is present in the composition in an amount ranging from 0.5% to 3.5% weight per weight (w/w) of the composition.

In some embodiments, the date syrup and the monk fruit derived material are in a w/w ratio ranging from 1:3 to 1:30.

In some embodiments, the oligosaccharide and the monk fruit derived material are in a w/w ratio ranging from 10:1 to 350:1.

In some embodiments, the oligosaccharide and the monk fruit derived material are in a ratio of 10:1 to 100:1 (w/w).

In some embodiments, the oligosaccharide is at least 30% (w/w) of the total weight of the composition.

In some embodiments, the monk fruit derived material comprises mogroside or any derivative thereof.

In some embodiments, the monk fruit derived material and the soluble fiber account for 30% (w/w) or less of the total weight of the composition.

In some embodiments, the oligosaccharide comprises isomalto-oligosaccharide, oligofructose, or any combination thereof.

In some embodiments, the isomalto-oligosaccharide comprises isomaltulose.

In some embodiments, the composition further comprises a fruit derived sugar, a fruit deionized juice, or a combination thereof.

In some embodiments, the fruit comprises an apple.

In some embodiments, the composition is in a particle or a liquid form.

In some embodiments, the composition of is semi-solid.

In some embodiments, the composition has a pH in the range of 5 to 8.

In some embodiments, the composition has a moisture content ranging from 1% to 30% (w/w) of the total weight of the composition.

In some embodiments, the composition has a glycemic index lower than 40.

In some embodiments, the composition has a total amount of dietary fibers in the range of 15% to 85% (w/w) of the total weight of the composition.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIG. 1 is a graph showing the showing the dynamics of sweetness intensity of different sugars, e.g., fructose, oligofructose, sucrose, and monk fruit, over time.

FIG. 2 is a graph showing the sweetness profile of the composition of the invention compared to sucrose. Compared to the various profiles described in FIG. 1, the inventor has dramatically reduced the amount of monk fruit by approximately 60%, adjusted the amount of fructose/oligofructose in order to elevate the sweetness profile at early consumption, and added date syrup, thereby masking the long lasting taste (e.g., lingering effect) of the monk fruit.

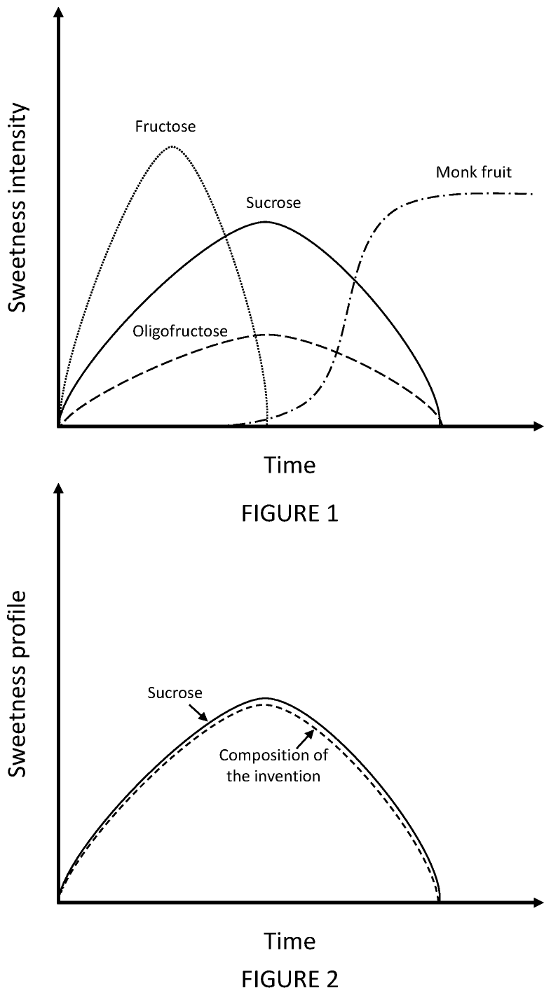

### DETAILED DESCRIPTION

According to some embodiments, there is provided a composition comprising: (a) an oligosaccharide; (b) a monk fruit derived material; (c) a soluble fiber; and (d) a flavor masking agent.

In some embodiments, the flavor masking agent comprises or consists of date syrup, date sugar, date concentrate, or any combination thereof.

As used herein, the term “flavor masking agent” encompasses any compound capable of covering bitterness, astringency, medicinal, metallic, general flavor off-notes, or any combination thereof.

According to some embodiments, the present invention provides a composition comprising an oligosaccharide, a natural high intensity sweetener, and a soluble fiber.

In some embodiments, the composition comprises an oligosaccharide in an amount of at least 40% (w/w), at least 45% (w/w), at least 46% (w/w), at least 49% (w/w), at least 50% (w/w), at least 55% (w/w), at least 57% (w/w), at least 58% (w/w), at least 59% (w/w), at least 60% (w/w), at least 61% (w/w), least 65% (w/w), at least 70% (w/w), at least 75% (w/w), 76% (w/w), at least 77% (w/w), at least 78% (w/w), or at least 80% (w/w) of the total weight of the composition, or any value and range therebetween. Each possibility represents a separate embodiment of the invention.

In some embodiments, the composition comprises an oligosaccharide in an amount ranging from 30% to 85% (w/w) of the total weight of the composition. In some embodiments, the composition comprises an oligosaccharide in an amount ranging from 40% to 80% (w/w) of the total weight of the composition. In some embodiments, the composition comprises an oligosaccharide in an amount ranging from 40% to 60% (w/w) of the total weight of the composition. In some embodiments, the composition comprises an oligosaccharide in an amount ranging from 40% to 50% (w/w) of the total weight of the composition. In some embodiments, the composition comprises an oligosaccharide in an amount ranging from 50% to 80% (w/w) of the total weight of the composition. In some embodiments, the composition comprises an oligosaccharide in a range of 50% to 70% (w/w). In some embodiments, the composition comprises an oligosaccharide in a range of 45% to 60% (w/w). In some embodiments, the composition comprises an oligosaccharide in a range of 60% to 80% (w/w). In some embodiments, the composition comprises an oligosaccharide in a range of 70% to 85% (w/w).

In some embodiments, the composition comprises a monk fruit derived material. As used herein, the term “monk fruit derived material” refers to any compound, extract, lysate, soluble or insoluble fraction derived or obtained from the monk fruit, and any combination thereof.

As used herein, the term “monk fruit” refers to the fruit of the herbaceous perennial vine, Siraitia grosvenorii, that is native to the tropical regions of South Eastern Asia. Concentrates and extracts from the monk fruit have been found to be approximately 15 times, and 400 times sweeter than sugar, respectively. The active compound in monk fruit concentrate or extract comprise triterpene glycosides or mogrosides, which comprise Mogroside II A1, Mogroside II B, 7-Oxomogroside II E, 11-Oxomogroside A1, Mogroside III A2, 11-Deoxymogroside III, 11-Oxomogroside IV A, Mogroside V, 7-Oxomogroside V, and 11-Oxo-mogroside V.

In some embodiments, the composition described herein comprises a monk fruit derived material. In some embodiments, the monk fruit derived material comprises juice or juice concentrate. In some embodiments, the monk fruit juice concentrate is derived, isolated, purified, extracted or obtained from the monk fruit (also known as Luo Han Guo), or a concentrate thereof.

In some embodiments, the monk fruit (i.e., Luo Han Guo), is subjected to an extraction procedure resulting in an extract. In some embodiments, the monk fruit derived material comprises mogroside V or other mogrosides in a concentrated or purified form. In some embodiments, the monk fruit or a product derived therefrom, is subjected to a concentration procedure resulting in a concentrate.

As used herein, the term “pulp” encompasses any insoluble material obtained or left after a juice is obtained from a fruit.

In some embodiments, monk fruit is a binding agent.

In some embodiments, a binding agent binds or links a polysaccharide to a fiber and/or a non-hygroscopic compound. In some embodiments, a binding agent binds or links a highly hygroscopic polysaccharide to a fiber and/or a non-hygroscopic compound. In some embodiments, a binding agent binds or links ingredients of the composition of the invention to a solid composition or a product.

In some embodiments, the monk fruit juice is in the form of a concentrate. In some embodiments, the monk fruit juice is in a solution form. In some embodiments, the monk fruit juice is in the form of a syrup. In some embodiments, the monk fruit juice is in the form of a concentrated aqueous solution. In some embodiments, the monk fruit juice is in a dry or powdered form.

In some embodiments, the monk fruit derived material comprises a monk fruit juice extract. In some embodiments, the monk fruit juice extract is a natural high intensity sweetener. In some embodiments, the monk fruit derived material is or comprises a natural high intensity sweetener. In some embodiments, a natural high intensity sweetener is natural, synthetic, or a combination thereof. In some embodiments, a natural high intensity sweetener is synthetic.

In some embodiments, the monk fruit derived material comprises mogroside or any derivative thereof. In some embodiments, the monk fruit derived material comprises mogroside V.

In some embodiments, the monk fruit derived material has a high mogroside(s) content. In some embodiments, the monk fruit derived material has at least 20% (w/w), at least 25% (w/w), at least 30% (w/w), at least 35% (w/w), at least 40% (w/w), at least 45% (w/w), at least 55% (w/w), at least 65% (w/w), at least 75% (w/w), at least 85% (w/w), at least 90% (w/w), or at least 95% (w/w) mogroside(s), or any value and range therebetween. Each possibility represents a separate embodiment of the invention. In some embodiments, the monk fruit derived material has 15-30% (w/w), 10-25% (w/w), 20-45% (w/w), 35-50% (w/w), 25-60% (w/w), 35-80% (w/w), 25-75% (w/w), 15-90% (w/w), or 20-95% (w/w) mogroside(s). Each possibility represents a separate embodiment of the invention.

In some embodiments, the monk fruit derived material has a high mogroside V content. In some embodiments, the monk fruit derived material, e.g., monk fruit juice concentrate, has at least 1% (w/w), at least 2% (w/w), at least 3% (w/w), at least 4% (w/w), or at least 5% (w/w), mogroside V, or any value and range therebetween. Each possibility represents a separate embodiment of the invention. In some embodiments, the monk fruit derived material, e.g., monk fruit juice extract, has at least 20% (w/w), at least 25% (w/w), at least 30% (w/w), at least 35% (w/w), at least 40% (w/w), or at least 45% (w/w) mogroside V, or any value and range therebetween. Each possibility represents a separate embodiment of the invention. In some embodiments, the monk fruit derived material, e.g., monk fruit juice concentrate, has 1-3% (w/w), 1-4% (w/w), 1-5% (w/w), 2-3% (w/w), 2-4% (w/w), 2-5% (w/w), 3-4% (w/w), 3-5% (w/w), or 4-5% (w/w) mogroside V. Each possibility represents a separate embodiment of the invention. In some embodiments, the monk fruit derived material, e.g., monk fruit juice extract, has 15-30% (w/w), 10-25% (w/w), 20-45% (w/w), 35-50% (w/w), or 25-60% (w/w) mogroside V. Each possibility represents a separate embodiment of the invention.

In some embodiments, the monk fruit derived material comprises one or more constituents, selected from: a terpene glycoside (such as mogroside II-IV and VI, 11-oxo mogroside V, grosmomoside I, and siamenoside I), a protein fragment, a melanoidin, a flavonoid, and any combination thereof.

In some embodiments, the composition comprises an oligosaccharide and mogroside V derived from a monk fruit derived material as disclosed hereinabove. In some embodiments, the composition comprises an oligosaccharide and a mogroside V derived from the monk fruit derived material in a w/w ratio of 99.9:0.1 to 99:1.

As used herein, the term “high intensity sweetener” refers to a substance used to sweeten and enhance the flavor of foods with little or no nutritive value. A “monk fruit high intensity sweetener” provides a high sweetness per unit mass as compared to a nutritive sweetener. In some embodiments, the monk fruit high intensity sweetener has a relative sweetening intensity (RSI) of at least 5 times that of sucrose. In some embodiments, the monk fruit high intensity sweetener has a RSI of at least 10 times, at least 20 times, at least 30 times, at least 50 times, at least 100 times, or at least 400 times that of sucrose, or any value and range therebetween. Each possibility represents a separate embodiment of the invention. In some embodiments, the monk fruit high intensity sweetener has RSI of 5-15 times, 10-25 times, 20-45 times, 5-70 times, 10-85 times, 45-90 times, 65-110 times, 100-250 times, 90-350 times, or 175-400 times that of sucrose. Each possibility represents a separate embodiment of the invention.

As used herein, the term “plant-based” refers to a compound or combination of compounds naturally providing the principle sweetness in a plant. It includes sweeteners modified by enzymatic or microbial means resulting in a compound or combination of compounds naturally providing the principle sweetness in a plant.

In some embodiments, the composition comprises a natural high intensity sweetener in a range of 0.05% to 10% (w/w). In some embodiments, the composition comprises a natural high intensity sweetener in a range of 0.05% to 5% (w/w). In some embodiments, the composition comprises a natural high intensity sweetener in a range of 0.05% to 0.5% (w/w). In some embodiments, the composition comprises a natural high intensity sweetener in a range of 0.05% to 0.3% (w/w). In some embodiments, the composition comprises a natural high intensity sweetener in a range of 0.05% to 0.4% (w/w). In some embodiments, the composition comprises a natural high intensity sweetener in a range of 0.05% to 1% (w/w).

In some embodiments, the composition comprises a soluble fiber in a range of 10% to 85% (w/w). In some embodiments, the composition comprises a soluble fiber in a range of 10% to 75% (w/w). In some embodiments, the composition comprises a soluble fiber in a range of 10% to 70% (w/w). In some embodiments, the composition comprises a soluble fiber in a range of 10% to 60% (w/w). In some embodiments, the composition comprises a soluble fiber in a range of 10% to 50% (w/w). In some embodiments, the composition comprises a soluble fiber in a range of 10% to 40% (w/w). In some embodiments, the composition comprises a soluble fiber in a range of 10% to 30% (w/w). In some embodiments, the composition comprises a soluble fiber in a range of 10% to 20% (w/w). In some embodiments, the composition comprises a soluble fiber in a range of 10% to 50% (w/w). In some embodiments, the composition comprises a soluble fiber in a range of 15% to 30% (w/w). In some embodiments, the composition comprises a soluble fiber in a range of 15% to 55% (w/w).

As used herein, the term “soluble” refers to solubility in a polar solvent. Non-limiting examples of polar solvents include, but are not limited to, water, buffer, cell culture media, and the like.

In some embodiments the composition comprises a monk fruit derived material, e.g., a natural high intensity sweetener, and a soluble fiber. In some embodiments, the monk fruit derived material and a soluble fiber account for 30% (w/w) or less of the total weight of the composition. In some embodiments, less than 30% (w/w) comprises 29% (w/w), 27% (w/w), 25% (w/w), 22% (w/w), 20% (w/w), 18% (w/w), 17% (w/w), 16% (w/w), 15% (w/w), 14% (w/w), 12% (w/w), 10% (w/w), 9% (w/w), 8% (w/w), 7% (w/w), 6% (w/w), 5% (w/w), 4% (w/w), 3% (w/w), 2% (w/w) or 1% (w/w). Each possibility represents a separate embodiment of the invention.

In some embodiments, the composition described herein comprises an oligosaccharide and a monk fruit derived material, e.g., a natural high intensity sweetener. In some embodiments the composition comprises an oligosaccharide and a monk fruit derived material, e.g., a juice concentrate, or an extract being a natural high intensity sweetener in a w/w ratio of 10:1 to 350:1. In some embodiments, the composition described herein comprises an oligosaccharide and a natural high intensity sweetener.

In some embodiments, the composition comprises an oligosaccharide and a monk fruit derived material in a w/w ratio of: 10:1 to 20:1, 10:1 to 35:1, 15:1 to 90:1, 50:1 to 300:1, 25:1 to 150:1, 125:1 to 290:1, or 100:1 to 350:1. Each possibility represents a separate embodiment of the invention.

In some embodiments, the composition comprises an oligosaccharide and a monk fruit juice concentrate in a w/w ratio ranging from 10:1 to 35:1, 15:1 to 40:1, or 10:1 to 50:1. Each possibility represents a separate embodiment of the invention.

In some embodiments, the composition comprises an oligosaccharide and a monk fruit juice extract in a w/w ratio ranging from 100:1 to 350:1, 150:1 to 400:1, or 10:1 to 500:1. Each possibility represents a separate embodiment of the invention.

In some embodiments, the composition described herein comprises a dietary fiber in an amount of at least 10% (w/w). In some embodiments, the composition comprises a dietary fiber in an amount of at least 15% (w/w). In some embodiments, the composition comprises a dietary fiber in an amount of at least 20% (w/w). In some embodiments, the composition comprises a dietary fiber in an amount of at least 25% (w/w). In some embodiments, the composition comprises a dietary fiber in an amount of at least 30% (w/w). In some embodiments, the composition comprises a dietary fiber in an amount of at least 50% (w/w). In some embodiments, the composition comprises a dietary fiber in an amount of at least 70% (w/w).

In some embodiments, the composition described herein comprises a dietary fiber in an amount in the range of 10% to 85% (w/w). In some embodiments, the composition comprises a dietary fiber in an amount in the range of 15% to 85% (w/w). In some embodiments, the composition comprises a dietary fiber in an amount in the range of 15% to 75% (w/w). In some embodiments, the composition comprises a dietary fiber in an amount in the range of 15% to 70% (w/w). In some embodiments, the composition comprises a dietary fiber in an amount in the range of 15% to 60% (w/w). In some embodiments, the composition comprises a dietary fiber in an amount in the range of 15% to 55% (w/w). In some embodiments, the composition comprises a dietary fiber in an amount in the range of 10% to 50% (w/w). In some embodiments, the composition comprises a dietary fiber in an amount in the range of 10% to 55% (w/w). In some embodiments, the composition comprises a dietary fiber in an amount in the range of 40% to 85% (w/w). In some embodiments, the composition comprises a dietary fiber in an amount in the range of 30% to 85% (w/w).

In some embodiments, the composition comprises a sweetener modulator. In some embodiments, the composition comprises a sweetener enhancer. In some embodiments, the composition comprises thaumatin. In some embodiments, the composition comprises RP44 (also known as Rebaudioside C, or Dulcoside B). in some embodiments, the sweetener enhancer is selected from thaumatin or RP44. In some embodiments, the composition comprises a masking flavor. In one embodiment, a masking flavor comprises natural yeast extract.

### Physical Properties

In some embodiments, the composition is in the form of a particle or a plurality of particles. In some embodiments, the composition is a liquid. In some embodiments, the composition is a semi-solid. In some embodiments, the composition is a solid.

In some embodiments, “plurality” comprises any integer greater than 2, or range thereof.

In some embodiments, the composition comprises a matrix of granules. In some embodiments, the composition comprises a cluster of granules. A non-limiting example for a process of producing a composition comprising a matrix of granules, a cluster of granules, or both, includes, but is not limited to, mixing water with compounds of the composition and dissolving some, but not all, of the compounds so as to obtain granules, and pressing the mixture comprising the water and granules, e.g., into a mold, and evaporating the water thereafter. Post-evaporation, at least a portion the granules are melted together, resulting in matrix of granules capable of holding its shape.

In some embodiments, a composition described herein has a bulk density ranging from about 0.3 to 1.4 g/ml. In some embodiments, a composition described herein has a bulk density ranging from about 0.3 to 0.9 g/ml. In some embodiments, the composition has a bulk density ranging from about 0.4 to 0.8 g/ml. In some embodiments, the composition has a bulk density ranging from about 0.4 to 0.7 g/ml. In some embodiments, the composition has a bulk density ranging from about 0.5 to 0.7 g/ml. In some embodiments, the composition has a bulk density ranging from about 0.5 to 0.8 g/ml.

In some embodiments, a composition described herein has a bulk density of about 0.3 g/ml, about 0.35 g/ml, about 0.4 g/ml, about 0.45 g/ml, about 0.5 g/ml, about 0.55 g/ml, about 0.6 g/ml, about 0.65 g/ml, 0.66 g/ml, about 0.67 g/ml, 0.68 g/ml, about 0.69 g/ml, about 0.7 g/ml, about 0.71 g/ml, about 0.72 g/ml, about 0.73 g/ml, about 0.74 g/ml, about 0.75 g/ml, about 0.76 g/ml, about 0.77 g/ml, about 0.78 g/ml, about 0.79 g/ml, or about 0.8 g/ml. Each possibility represents a separate embodiment of the invention.

In some embodiments, a composition described herein has a moisture content ranging from about 1% to 40% (w/w). In some embodiments, the composition has a moisture content ranging from about 1% to 30% (w/w). In some embodiments, the composition has a moisture content ranging from about 2% to 30% (w/w). In some embodiments, the composition has a moisture content ranging from about 5% to 30% (w/w). In some embodiments, the composition has a moisture content ranging from about 1% to 5% (w/w). In some embodiments, the composition has a moisture content ranging from about 2% to 5% (w/w). In some embodiments, the composition has a moisture content ranging from about 1% to 10% (w/w).

In some embodiments, the composition described herein has a pH in the range of about 4 to 8. In some embodiments, the composition described herein has a pH in the range of about 5.5 to 7.5. In some embodiments, the composition described herein has a pH in the range of about 6 to 8. In some embodiments, the composition described herein has a pH in the range of about 5 to 7.

As used herein, the term “semi-solid” refers to a material that is a mixture of liquid and solid phases. Semi-solids include, for example, a particle suspension, colloidal suspension, paste, emulsion, gel, micelle, and similar materials having a viscosity of a level such that the material does not flow quickly or easily under gravity, and that tends to smear when wiped. Non-limiting examples of semi-solid materials include toothpaste, moist modeling clay, and vacuum grease.

### Oligosaccharide

In some embodiments, the composition described herein comprises an oligosaccharide. In some embodiments, the composition comprises oligofructose. In some embodiments, the composition comprises isomalto-oligosaccharide (i.e., IMO). In some embodiments, the composition comprises isomaltulose.

As used herein, the term “oligosaccharide” encompasses any polymer comprising 2 or more monosaccharides.

As used herein, the term “oligosaccharide” encompasses a disaccharide. In some embodiments, an oligosaccharide comprises a single oligosaccharide or a mixture/plurality of oligosaccharides. In some embodiments, the composition comprises a mixture/plurality of oligosaccharides. In some embodiments, the composition comprises a mixture of a fructooligosaccharides and an isomalto-oligosaccharide.

As used herein, the term “oligofructose” refers to a mixture of specific fructooligosaccharides comprising two or more fructose molecules linked by a (3-1,2 bond(s). A glucose molecule often occurs at the end of the chain. The “degree of polymerization” or DP gives the total number of molecules that are linked. In some embodiments, an oligofructose as disclosed herein is defined as inulin and inulin-oligosaccharides. In some embodiments, the sweetness intensity of a frucooligosaccharide is 25-45% the sweetness intensity of a sugar.

As used herein, the term “isomalto-oligosaccharide” refers to a mixture of specific glucooligosaccharides comprising two to nine glucose molecules linked by digestion-resistant α-1,6 bond(s). An isomalto-oligosaccharide having DP=2 is isomaltulose. In some embodiments, the sweetness intensity of an isomalto-oligosaccharide is 45-65% the sweetness intensity of a sugar. In some embodiments, an isomalto-oligosaccharide withstands acidic conditions, basic conditions, or both. In some embodiments, an isomalto-oligosaccharide withstands pH ranging from 2-4, 3-8, 4-9, 2-9, 5-8, or 3-7. As used herein, the term “withstand” refers to a physico-chemical property of a compound not to break down or degrade due to exposure to a physical or chemical environmental factor.

In some embodiments, oligosaccharide, such as isomalto-oligosaccharide or oligofructose, or a combination thereof, acts as an encapsulating or agglomerating agent. In some embodiments, the oligosaccharide is able to absorb other ingredients. In some embodiments, the oligosaccharide is able to encapsulate, agglomerate or absorb high-intensity sweeteners. In some embodiments, the oligosaccharide is coated with non-hygroscopic soluble fiber. In some embodiments, oligofructose is coated with isomaltulose. In some embodiments, monk fruit concentrate acts as a binder between oligosaccharide and non-hygroscopic soluble fiber. In some embodiments, monk fruit concentrate acts as a binder between oligofructose and isomaltulose.

In some embodiments, a composition described herein comprises isomalto-oligosaccharide in a range of about 40% to 50% (w/w).

As used herein, the terms “isomaltulose” or “palatinose” refer to a crystalline reducing disaccharide that comprises one glucose moiety and one fructose moiety linked by an α-1,6-glycosidic bond. Palatinose is a carbohydrate bulking agent that is similar to sucrose, but low in sweetness intensity. Although palatinose is an isomer of sucrose, its sweetness intensity is only 42% the sweet intensity of sucrose. The chemical name of “isomaltulose” or “palatinose” is 6-O-α-D glucopyranosyl-D-fructose.

As used herein the term “oligosaccharide” refers to linear or branched molecules comprising two or more but less than 10 saccharide repeating units. Such repeating units may be the same or differ from one another. If a compound is present in the form of a mixture of molecules having different degrees of polymerization, the compound is to be regarded as an oligosaccharide if its average degree of polymerization (i.e., DP) is less than 10. In some embodiments the oligosaccharide is a disaccharide.

In some embodiments, the composition comprises date syrup, date sugar, date concentrate, date fibers, or any combination thereof, in the amount of at least 0.5% (w/w), at least 1% (w/w), at least 1.5% (w/w), at least 2% (w/w), at least 2.5% (w/w), or at least 3% (w/w), or any value and range therebetween. Each possibility represents a separate embodiment of the invention. In some embodiments, the composition comprises date syrup, date sugar, date concentrate, date fibers, or any combination thereof, in the amount of 1% to 6% (w/w), 1.5% to 5.5% (w/w), 2% to 4.5% (w/w), or 0.1% to 4.5% (w/w). Each possibility represents a separate embodiment of the invention.

In some embodiments, the term “date syrup”, “date sugar”, “date concentrate”, and “date fibers” are derived from any species of date and/or material extracted or obtained from same, wherein the syrup, sugar, concentrate, fibers, or any combination thereof, is characterized by having a Brix value ranging from 75 to 80, total solids (%) ranging from 74 to 80, Mpm-solubles % ranging from 0.001 to 1.5, sugar invert % ranging from 65 to 75, sugar (sucrose) % ranging from 0.6 to 3.5, protein (s) % ranging from 0.5 to 1.4, tannin % ranging from 0.01 to 0.5, total pectin (as pure Ca-pectate) % ranging from 0.15 to 0.8, methoxyl s content of the pectin % ranging from 3.5 to 6, acidity (as citric acid b/100 g syrup) ranging from 0.35 to 0.95, Ash % ranging from 1 to 2.5, pH ranging from 3.7 to 5, or any combination thereof.

In some embodiments, the “date syrup”, “date sugar”, “date concentrate”, or “date fibers”, comprises a purified, filtered, fractionated, deionized, chemically treated, decolorated, or any combination thereof, of “date syrup”, “date sugar”, “date concentrate”, and “date fibers”.

In some embodiments, the “date syrup”, “date sugar”, “date concentrate”, or “date fibers”, is a retentate of “date syrup”, “date sugar”, “date concentrate”, or “date fibers”.

As used herein, the term “retentate” refers to a material obtained after purification, filtration, fractionation, deionization, chemically treatment, decoloration, or any combination thereof.

The terms “date syrup”, “date sugar”, “date concentrate”, and “date fibers”, are used herein interchangeably.

In some embodiments, the masking agent is characterized by having a Brix value ranging from 75 to 80, total solids (%) ranging from 74 to 80, Mpm-solubles % ranging from 0.001 to 1.5, sugar invert % ranging from 65 to 75, sugar (sucrose) % ranging from 0.6 to 3.5, protein (s) % ranging from 0.5 to 1.4, tannin % ranging from 0.01 to 0.5, total pectin (as pure Ca-pectate) % ranging from 0.15 to 0.8, methoxyl s content of the pectin % ranging from 3.5 to 6, acidity (as citric acid b/100 g syrup) ranging from 0.35 to 0.95, Ash % ranging from 1 to 2.5, pH ranging from 3.7 to 5, or any combination thereof.

In some embodiments, the composition further comprises honey, honey sugar, or any combination thereof. As used herein, the term “honey sugar” refers to any one of dried or ground honey which comprises dried honey particles. In some embodiments, the composition comprises honey sugar in the amount of at least 0.5% (w/w), at least 1% (w/w), at least 2% (w/w), at least 3% (w/w), at least 4% (w/w), or at least 5% (w/w), or any value and range therebetween. Each possibility represents a separate embodiment of the invention.

### Soluble Fiber

In some embodiments, the composition described herein comprises a soluble fiber.

As used herein the term “fiber” refers to carbohydrate polymers with at least 10 monomeric units, which are not hydrolyzed by the endogenous enzymes in the small intestine of humans. Fiber can be soluble in water (i.e., “soluble”) or insoluble in water (i.e., “insoluble”). Many microalgae produce both soluble and insoluble fiber, typically residing in the cell wall.

In some embodiments, a soluble fiber is wheat based. In some embodiments, a soluble fiber is maize based. In some embodiments, a soluble fiber is dextrin(s) (e.g., NUTRIOSE®).

In some embodiments, a soluble fiber is from acacia. In some embodiments, a soluble fiber is isolated, purified, derived, obtained, or extracted from acacia trees. In some embodiments, a soluble fiber from acacia is Fibregum™.

In some embodiments, a soluble fiber comprises a polymer of glucose such as polydextrose. In some embodiments, a soluble fiber comprises a legume fiber, for example, pea fiber.

In some embodiments, a soluble fiber is bran, e.g., a wheat bran, oat bran, corn bran, rice bran, or other bran. In some embodiments, the bran can be micronized into a fine powder.

In some embodiments, a soluble fiber comprises raffinose, polydextrose, fructans, polyuronide, or lactulose.

In some embodiments, a soluble fiber is a dietary fiber.

As used herein, the term “dietary fiber” refers to any carbohydrate polymer which cannot be completely broken down by digestive enzymes, e.g., human enzymes. In some embodiments, dietary fibers comprise non-starch carbohydrates, e.g., as can be found in plants and/or other organisms containing cell walls, including microalgae. In some embodiments, dietary fibers comprise resistant starch, e.g., cannot be completely broken down by digestive enzymes. Dietary fiber can be soluble (i.e., dissolved in water) or insoluble (i.e., not able to be dissolved in water). Soluble and insoluble fiber makes up total dietary fiber.

In some embodiments, a dietary fiber is a water-insoluble fiber. In some embodiments a water-insoluble fiber comprises cellulose, hemicellulose, lignin, and xanthan.

In some embodiments, a composition described herein comprises non-hygroscopic soluble fiber in a range of about 30% to 60% (w/w). In some embodiments, a composition described herein comprises non-hygroscopic soluble fiber in a range of about 40% to 50% (w/w). In some embodiments, a composition described herein comprises non-hygroscopic soluble fiber in a range of about 44% to 50% (w/w).

In some embodiments, “soluble fiber” and/or “polysaccharide” comprises or consists of resistant starch. In some embodiments, resistant starch is selected from R1, R2, R3, or R4 resistant starch. In some embodiments, a polysaccharide comprises or consists of inulin. In some embodiments, a polysaccharide comprises or consists of cellulose. In some embodiments, the polysaccharide is a filler. In some embodiments, the polysaccharide is a thickening agent. In some embodiments, the polysaccharide is used to replace flour and/or starch. In some embodiments, the polysaccharide can be used to replace flour/starch in a composition and/or product selected from: pastry, pudding, porridge, thick drinks (e.g., smoothies, shakes, etc.), and others. Non-limiting examples of resistant starch include, but are not limited to, HIMAIZE 1043 (R2 resistant starch), NOVOLOSE 330 (R3 resistant starch), among others.

In some embodiments, the composition further comprising a fruit derived sugar, a fruit deionized juice, or a combination thereof.

In some embodiments, the fruit derived sugar, the fruit deionized juice, or a combination thereof, is enriched with fructose and comprises low amounts of dextrose and/or sucrose.

In some embodiments, the sugar is a rare sugar. In one embodiment, a sugar is a syrup comprising allulose. In one embodiment, a sugar is a syrup comprising allulose and fructose. In one embodiment, a sugar is a syrup comprising D-allulose and low amounts of fructose. In some embodiments, a sugar is deionized fruit juice. In some embodiments, the composition described herein further comprises a sugar in an amount of 2-20% (w/w), 1-15% (w/w), 3-15% (w/w), or 4-25% (w/w) of the total weight of the composition. Each possibility represents a separate embodiment of the invention. In some embodiments, the composition further comprises a rare sugar in an amount of at least 2% (w/w), at least 5% (w/w), at least 7% (w/w), at least 9% (w/w), at least 12% (w/w), at least 15% (w/w), at least 17% (w/w), or at least 20% (w/w) of the total weight of the composition, or any value and range therebetween. Each possibility represents a separate embodiment of the invention.

For example, Apple is suitable as it includes high fructose amounts and is low on dextrose and/or sucrose. The more fructose the greater the sweetness (1.3 compared to 1 of sucrose and 0.5 of dextrose). Other fruit concentrates, e.g., grapes, oranges, pineapple, carob syrup, are low on fructose, and enriched with dextrose and/or sucrose. Pear for example is enriched with fructose but when examining the total solids in pear juice, the sorbitol % is extremely high, i.e., 10-25%\, with a relatively reduced sweetness compared to fructose and sucrose.

In some embodiments, the composition further comprising an apple derived sugar, an apple deionized juice, or a combination thereof.

In some embodiments, the composition further comprises amino acid, a peptide, a polypeptide, a protein, or any combination thereof, wherein the amino acid, a peptide, a polypeptide, a protein, or any combination thereof, further enhance the sweetness intensity of the composition. In some embodiments, the composition comprises the amino acid glycine. In one embodiment, the sweetness intensity of glycine is 65-75% the sweetness intensity of sugar.

In some embodiments, the composition further comprises a natural flavor compound. In some embodiments, the composition further comprises a food additive. In some embodiments, the composition further comprises a color additive. Types of food and color additives would be apparent to one of ordinary skill in the art. Non-limiting examples of food and color additives and flavoring substances are listed in FDA regulations (21 CFR Parts 172, 173 and Parts 73, 74 respectively), evaluated by the Flavor and Extract Manufacturers Association (FEMA), and/or the Joint Expert Committee on Food Additives (JECFA). In some embodiments, the natural flavor compound comprises nsf 04. In some embodiments, the natural flavor compound is present in the composition in an amount ranging from 0.01 to 0.5. In some embodiments, the natural flavor compound is or comprises a natural flavor masking agent.

### Glycemic Index

In some embodiments, the composition has a glycemic index lower than sugar. In some embodiments, the composition has a glycemic index lower than sucrose.

In some embodiments, the composition has a glycemic index lower than sucrose and maintains the same sweetness profile.

In some embodiments, the composition has a glycemic index equal to or less than 55 (i.e., “Low GI”). In some embodiments, a composition having low GI has a glycemic index lower than 40. In some embodiments, a composition having low GI has a glycemic index lower than 35. In some embodiments, a composition having low GI has a glycemic index lower than 30.

In some embodiments, a composition having a low GI has a glycemic index in the range of 0 to 40. In some embodiments, a composition having a low GI has a glycemic index in the range of 0 to 35. In some embodiments, a composition having low GI has a glycemic index in the range of 0 to 30. In some embodiments, a composition having low GI has a glycemic index in the range of 0 to 27. In some embodiments, a composition having low GI has a glycemic index in the range of 0 to 26. In some embodiments, a composition having low GI has a glycemic index in the range of 0 to 25. In some embodiments, a composition having low GI has a glycemic index in the range of 1 to 25. In some embodiments, a composition having low GI has a glycemic index in the range of 5 to 25.

As used herein the term “sugar” refers to any type of simple carbohydrate, such as a mono or disaccharide, either naturally obtained or refined from a natural source, or synthetically or artificially produced, and includes, without limitation, sucrose, dextrose, maltose, glucose, fructose, galactose, mannose, lactose, trehalose, lactulose, levulose, raffinose, ribose, or xylose. In some embodiments, the sugar is sucrose. The term “sugar,” as used herein, also includes various “sugar substitutes” that are widely known to a person of ordinary skill in the art of preparing solid dosage forms, such as the polyhydric alcohols (sometimes referred to as “sugar alcohols” or hydrogenated saccharides), for example sorbitol, mannitol, xylitol, and erythritol, and the sugar derivatives of polyhydric alcohols, such as maltitol, lactitol, isomalt, and polyalditol.

As used herein the term “glycemic index” or “GI” refers to incremental area under the blood glucose response curve of a composition that is expressed as a percentage of the response to the reference composition (with the same amount of available carbohydrate) which, by convention, is glucose.

As used herein the term “sweetness profile” refers to a combination of sweetness perception, temporal effects of sweetness perception, i.e., on-set and duration, off-tastes, e.g., bitterness and metallic taste, residual perception (aftertaste), and tactile perception, e.g., body and thickness.

### The Method

According to some embodiments, the present invention provides a method for preparing food products that require an amount of sugar, the method comprising substituting the amount of sugar that is required for preparing the food product with an equivalent amount of the composition described herein.

In some embodiments, an equivalent amount is a desired amount of consumption. In some embodiments, an equivalent amount is a spoon. In some embodiments, an equivalent amount is a teaspoon.

Non-limiting examples of food products that require an amount of sugar may be selected from: drink products, juices, confectionary products, dessert products, cereal products, baked goods, frozen dairy products, meats, dairy products, condiments, snack bars, soups, dressings, mixes, prepared foods, baby foods, diet preparations, syrups, food coatings, dried fruits, sauces, gravies, jams/jellies, spreads, batters, breadings, spice mixes, frostings, and coatings.

In some embodiments, the present invention is directed to a composition that can be used as a sugar substitute.

As used herein, the term “sugar substitute” refers to a composition which is effective in replacing sugars (i.e., sucrose, fructose, glucose, etc.) in food compositions and provides sugar-like functionality in the form of degree of hydration, sweetness, shape, viscosity, color, texture, odor, presentation and bulk, or any combination thereof, but with significantly reduced: calories, carbohydrates availability, glycemic index, or any combination thereof.

In some embodiments, the composition described herein has all of the characteristics and performs in a substantially similar manner to sugar in baking applications.

### General

As used herein the term “about” refers to ±10% or ±5%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Liquid Form Composition

Mixture of liquid oligofructose 94% and 6% monk fruit juice concentrate.

Liquid oligofructose: dry mater 75%; density 1.39 kg/L at 20° C.; viscosity 4000 MPAS AT 20° C.

Monk fruit juice concentrate: 65-70 BRIX.

This composition resulted in a sweetness profile over time as described herein.

A flavoring agent, a flavor masking agent, or both can be added to the above described composition, in an amount ranging from 2 to 600 ppm. Examples for such agents include a mushroom extract which blocks off-flavor effects such as bitterness (e.g., ClearTaste), and yeast extract.

### Example 2

### Particles Form Composition

Oligofructose about 65%, spayed with about 6% monk fruit concentrate and coated with non-hygroscopic soluble fiber or isomaltulose crystalline reducing disaccharide about 35%. After blending/mixing these compounds, the composition was dried, e.g., at 80° C., to a moisture level of 1-5% (w/w). This composition resulted in a sweetness profile over time as described herein.

Isomalto-oligosaccharide about 65%, spayed with about 6% monk fruit concentrate and coated with non-hygroscopic soluble fiber or isomaltulose crystalline reducing disaccharide about 35%. This composition resulted in a sweetness profile over time as described herein.

### Example 3

### Solid Form Composition

A blend of about 45% isomaltulose crystalline, blended with about 6% monk fruit concentrate and about 45% non-hygroscopic soluble fiber. After blending these compounds, the composition was dried to a moisture level of 1-5% (w/w). This composition resulted in a sweetness profile over time as described herein.

### Example 4

### Rheological Performance

The dried composition from Example 2 was packed, sealed, and maintained for a period of approximately a year in ambient conditions. During this period, the seal was re-opened and re-sealed numerous times. During this period, no aggregates, chunks, and the like were observed in the dried composition. Rheological performance examinations further demonstrated free flowing of the dried composition.

### Example 5

### Comparative Analysis of MFJC Vs. MFJE

The inventor compared between the sweetness profile of compositions comprising either monk fruit juice extract (MFJE) or monk fruit juice concentrate (MFJC) as the natural high intensity sweetener. Criteria for comparison included: sweetness duration, off-tastes, e.g., bitterness and metallic taste, residual perception (aftertaste), and tactile perception, e.g., body and thickness, and are summarized in the table below.

| | Masking | | | |
|---|---|---|---|---|
| | blockers from | | | Sugar |
| SENSORY | yeast or | MFJE/ | MFJC/ | BRIX |
| EVALUATION | mushroom | 100 g | 100 g | % |
| MFJE - enhanced | | 0.03 | 0.26 | 3 |
| sweetness, aftertaste, | | | | |
| metallic taste, prolonged | | | | |
| duration (e.g., lingering) | | | | |
| MFJC - sugar-like | | | | |
| sweetness, no aftertaste | | | | |
| in the upper palate, | | | | |
| reduced mouth dryness | | | | |
| sensation after drinking | | | | |
| MFJE - enhanced | | 0.086 | 0.74 | 6 |
| sweetness, aftertaste, | | | | |
| metallic taste, prolonged | | | | |
| duration (e.g., lingering) | | | | |
| MFJC - sugar-like | | | | |
| sweetness, no aftertaste | | | | |
| in the upper palate, | | | | |
| reduced mouth dryness | | | | |
| sensation after drinking | | | | |
| MFJE provides sweetness | | 0.167 | 1.43 | 9 |
| sensation similar to other | | | | |
| HIS (high intensity | | | | |
| sweetener) | | | | |
| MFJC combined with | 5-50 ppm | 0.086 | 0.74 | 6 |
| masking blockers provides | | | | |
| short and sufficient | | | | |
| sweetness sensation with | | | | |
| no aftertaste | | | | |

The results show that even though the amount of mogrosides was the same, and specifically that the amount of the mogroside V was the same, there was a significant difference in the sweetness profile, i.e., the texture sensation, and the aftertaste, providing a clear and strong preference for using MFJC over MFJE.

### Example 6

In addition to good nutritional values, date concentrated water extract, especially of the Mejool type, has the ability to dually mask off-flavors, like: (a) high-sweeteners, such as monk fruit extracts, stevia, etc.; and (b) bitter and/or metallic taste, such as by calcium.

There are 11 types of mogrosides in the monochromatic extraction of the monk fruit. The sweetest type of mogroside is the mogroside V, which is present in the highest concentration in the extract and is therefore separated. However, mogroside V has a negative characteristic which attributes to an unwanted lingering sensation, i.e., the unique sweetness effect of monk fruit lasts longer than other sugars.

The inventor suggested to combine date syrup, date sugar, or any combination thereof with high intensity sweetener (HIS), when the date syrup or the date sugar was used for masking off-flavors and not as a sweetener. The dose of the date syrup as a sugar was equivalent to 1% by weight of sucrose. Date Syrup has the following values: Total carbohydrates and sugars-66% by weight, of which 42-45% by weight is fructose, with a glycemic value of 47 compared to the value of 67 of sugars. Date syrup is rich in antioxidants (about 53 types of polyphenols, and minerals, such as potassium and magnesium).

Quantities: to mask the typical side effects of monk fruit, 100 ml of water were mixed with monk fruit juice concentrate (0.55 grams=sweetened with 5% sugar. Brix 5) and 1% date syrup. Advantages: this composition did not have the characteristic taste of date syrup and therefore did not affect the taste of the water, insignificantly affected the water coloration, and had a caloric value as little as 2 kilocalories per 100 gr of product.

As opposed to fruit extracts (e.g., monk fruit), the herein disclosed product did not affect drinks or basic products such as milk in terms of acidity, protein synthesis and others. Furthermore, fruit extracts do not mask off-flavors while being used at the same dosage as used in the disclosed product.

Honey sugar, that is dried and ground honey (can be ground to a desired size of particles per application) can be used as both a bulking agent and an off-flavor masking agent in non-liquid products, e.g., baking products, breads, cereal, health snacks, and porridges. Adding honey sugar in the amount of 2-5% by weight of the final product, contributed about 1-2% by weight to the total amount of sugars in the product. This allowed the inventor to lower the level of sweet soluble fiber of Isomalto oligosaccharide of oligofructose. Other advantage of combining soluble and insoluble fibers stems from the fact that the daily intake of soluble fiber is limited to 20-30 gr/day, and the ability to use date syrup allows to reduce the amount of oligosaccharides a quantity to an amount which allows for high consumption of products such as disclosed herein.

### Example 7

The inventor further examined whether the amount of MFJC can be reduced while maintaining the sweetness and sweetness profile of the composition.

The inventors reduced MFJC by 50% by mixing MFJC, Deionized fruit juice and date syrup so as to: (1) mask the typical side effects (off-flavor) of monk fruit (either MFJC or MFJE), and (2) enhance the sweetness of the composition (as expected by the reduction of MFJC).

Date syrup: concentrated water extract of dates (72-76% dry matter, 64-68% sugars). Date syrup is rich with: phytochemicals having antioxidant activity, such as carotenoids and phenols, and minerals, e.g., potassium, magnesium, etc.

Date syrup ingredients per 100 gr comprises: protein (5 gr), carbohydrates (67 gr) of which 65 gr are sugars (˜32 gr fructose, and ˜33 gr glucose), and fibers (3 gr).

| | Quantity | Quantity | | | | Resistant | |
|---|---|---|---|---|---|---|---|
| Ingredient | (gr) | (%) | | Fibers | Sugars | sugar | 1100 |
| MFJC 3.5 | 15 | 3.8 | | | 2.5 | | |
| IMO | 300 | 75.9 | | 38 | 2 | 5.7 | |
| Natural | 0.25 | 0.1 | | | | | |
| extract 04 | | | | | | | |
| NFS | | | | | | | |
| Date syrup | 10 | 2.5 | | 0.05 | 1.65 | | |
| Deionized | 70 | 17.7 | | | 12.3 | | |
| apple | | | | | | | |
| concentrate | | | | | | | |
| Total | 395.25 | 100.0 | 100 gr | 38.05 | 18.45 | 5.7 | Liquid |
| | | | | | | | syrup |
| | | | 100 gr | 0 | 98 | 0 | Sugar |

### Example 8

The inventor further compared date syrup % in different amount and its suitability to replace sugar in ratio of 1:1.

| | | | | | | Deionized | |
|---|---|---|---|---|---|---|---|
| | | Nutriose 6 | | | | Apple Juice | |
| | Iso-Malto | (Resistant | | | MFJC (3.5% | Fruit Con. | Date Syrup |
| Ingredients | Oligosaccahride | Dextrin) | Oligofructose | Palatinose | Mogroside V) | (70%) | (70%) |
| Experiment 1 | 75.9 | | | | 3.8 | 17.7 | 2.5 |
| Experiment 2 | 75.9 | | | | 3.8 | 17.7 | 0.5 |
| Experiment 3 | 75.9 | | | | 3.8 | 17.7 | 1 |
| Experiment 4 | | 20 | 30 | 40 | 3.75 | 5 | 1 |
| Experiment 5 | | 42 | | 48 | 3.75 | 5 | 1 |

| | | | | | Coloration ** |
|---|---|---|---|---|---|
| | Natural Flavor | | Organoleptic | After | (prior dilution |
| Ingredients | (nsf 04) | Date:Mogroside V | score * | Taste | in the end product) |
| Experiment 1 | 0.1 | 1:18 | 5 | +++ | 2.9 |
| Experiment 2 | 0.1 | 3.75:1 | 4.4 | − | 2.6 |
| Experiment 3 | 0.1 | 7.5:1 | 4.9 | ++ | 2.75 |
| Experiment 4 | 0.06 | 7.5:1 | 5*** | +++ | 2.5 |
| Experiment 5 | 0.06 | 7.5:1 | 5 | +++ | 2.5 |

* Sweetness profile intensity compared to sucrose, 5—closest to sucrose; 1—farthest from sucrose.
** Coloration. 1—very light coloration compared to a sucrose solution at the same concentration; 2.5—similar coloration compared to a sucrose solution at the same concentration; and 5—very dark coloration compared to a sucrose solution at the same concentration.
***Provided as candy (not solubilized or mixed in a composition with other ingredients but provided per se).

1. A composition comprising:
a. an oligosaccharide;
b. a monk fruit derived material;
c. a soluble fiber; and
d. date syrup.

2. The composition of claim 1, wherein said monk fruit derived material is selected from the group consisting of: monk fruit juice concentrate, monk fruit extract, monk fruit pulp, and any combination thereof.

3. The composition of claim 1, wherein said date syrup is present in said composition in an amount ranging from 0.5% to 3.5% weight per weight (w/w) of said composition.

4. The composition of claim 1, wherein said date syrup and said monk fruit derived material are in a w/w ratio ranging from 1:3 to 1:20.

5. The composition of claim 1, wherein said oligosaccharide and said monk fruit derived material are in a w/w ratio ranging from 10:1 to 350:1.

6. The composition of claim 1, wherein said oligosaccharide and said monk fruit derived material are in a ratio of 10:1 to 100:1 (w/w).

7. The composition of claim 1, wherein said oligosaccharide is at least 30% (w/w) of the total weight of the composition.

8. The composition of claim 1, wherein said monk fruit derived material comprises mogroside or any derivative thereof.

9. The composition of claim 1, wherein said monk fruit derived material and said soluble fiber account for 30% (w/w) or less of the total weight of said composition.

10. The composition of claim 1, wherein said oligosaccharide comprises isomalto-oligosaccharide, oligofructose, or any combination thereof.

11. The composition of claim 10, wherein said isomalto-oligosaccharide comprises isomaltulose.

12. The composition of claim 1, further comprising a fruit derived sugar, a fruit deionized juice, or a combination thereof.

13. The composition of claim 12, wherein said fruit comprises an apple.

14. The composition of claim 1, being in a particle or a liquid form.

15. The composition of claim 1, being semi-solid.

16. The composition of claim 1, having a pH in the range of 5 to 8.

17. The composition of claim 1, having a moisture content ranging from 1% to 30% (w/w) of the total weight of said composition.

18. The composition of claim 1, having a glycemic index lower than 40.

19. The composition of claim 1, having a total amount of dietary fibers in the range of 15% to 85% (w/w) of the total weight of said composition.

20. A method for preparing a food product that requires an amount of sugar, comprising substituting an amount of sugar required for preparing said food product with an equivalent amount of the composition of claim 1.
